(19) United States
(12) Patent Application Publication
(10) Pub. No.: US 2012/0100398 A1
(43) Pub. Date: Apr. 26, 2012

(54) APPLE-IPAD HOLDER TYPE BATTERY PACK

(76) Inventor: CHIH-HSING LEE, TAIPEI COUNTY (TW)

(21) Appl. No.: 12/908,190

(22) Filed: Oct. 20, 2010

(51) Int. Cl. H01M 2/02

(52) U.S. Cl. 429/7

(57) ABSTRACT

An APPLE-iPad holder type battery pack configured to hold and charge an APPLE-iPad, having a pair of high-definition speakers for output of audio signal from the APPLE-iPad and a support pivotally hinged to the back side thereof for supporting the APPLE-iPad on a flat surface in one of a series of tilting positions.

### BACKGROUND OF THE INVENTION

1. Field of the Invention

The present invention relates to an APPLE-iPad holder and more particularly, to an APPLE-iPad holder type battery pack adapted for holding an APPLE-iPad and charging the built-in battery of the APPLE-iPad held therein and having a pair of high-definition speakers for output of audio signal from the APPLE-iPad.

2. Description of the Related Art

On Jan. 27, 2010, Apple® introduced iPad 10 (see FIGS. 1 and 2), a revolutionary device for browsing the web, reading and sending email, enjoying photos, watching videos, listening to music, playing games, reading e-books and much more. However, this revolutionary device still has drawbacks.

As the rechargeable battery of an i-Pad 10 is a built-in component, it is not detachable. When the power of the built-in rechargeable battery is low, the user must use a mating battery charger to charge the built-in rechargeable battery. If the built-in rechargeable battery fails, the user must send the i-Pad to the distributor for repair or replacement of the built-in rechargeable battery.

### SUMMARY OF THE INVENTION

The present invention has been accomplished under the circumstances in view. It is one object of the present invention to provide an APPLE-iPad holder type battery pack, which is configured to hold and charge an APPLE-iPad. It is another object of the present invention to provide an APPLE-iPad holder type battery pack, which has high-definition speakers for voice output of the APPLE-iPad held therein.

To achieve these and other objects of the present invention, an APPLE-iPad holder type battery pack comprises a battery pack body configured to hold and charge an APPLE-iPad, a sliding panel coupled to and movable in and out of the battery pack body for holding an APPLE-iPad on the battery pack body for charging, a pair of high-definition speakers installed in the back side of the battery pack body for output of audio signal from the APPLE-iPad and a support pivotally hinged to the back side of the battery pack body for supporting the APPLE-iPad on a flat surface in one of a series of tilting positions. Further, a volume control for regulating the sound volume of the speakers, a power switch for power on/off control and power level indictor light set for indication the level of power are installed in the back side of the battery pack body.

### BRIEF DESCRIPTION OF THE DRAWINGS

FIG. 1 is an elevational view of an APPLE-iPad.

FIG. 2 is a rear side view of an APPLE-iPad.

FIG. 3 illustrates an i-Pad held in an APPLE-iPad holder type battery pack in accordance with the present invention.

FIG. 4 is an enlarged view of a part of FIG. 3.

FIG. 5 corresponds to FIG. 3, illustrating the sliding panel received and the loaded APPLE-iPad held firmly on the battery pack body.

FIG. 6 is a back side view of the APPLE-iPad holder type battery pack in accordance with the present invention.

FIG. 7 is another back side view of the APPLE-iPad holder type battery pack in accordance with the present invention.

FIG. 8 is a schematic side view of the present invention, illustrating an APPLE-iPad held in the APPLE-iPad holder type battery pack supported on a flat surface in a tilted position.

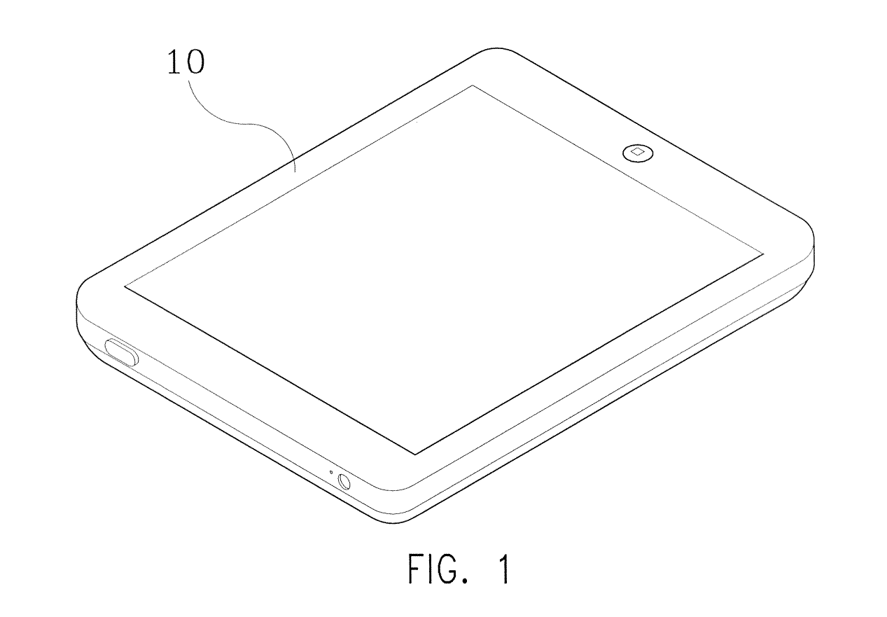

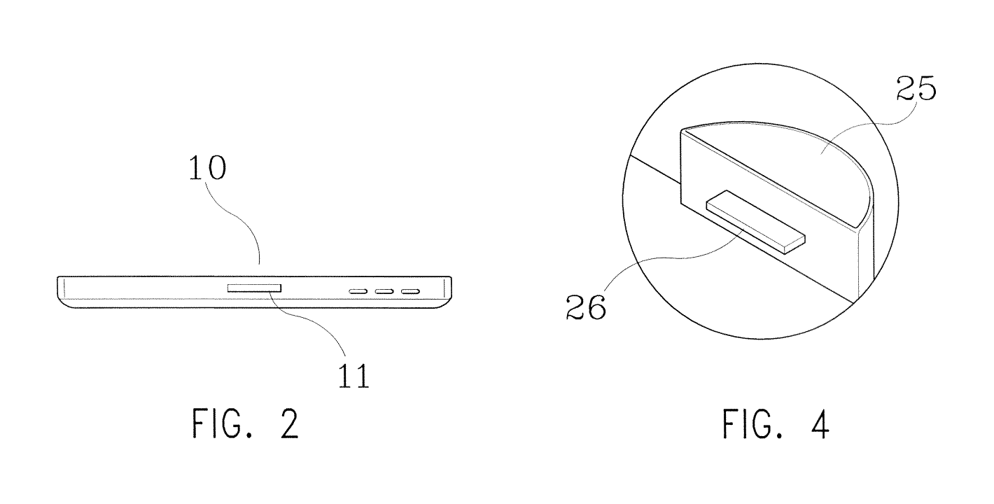

### DETAILED DESCRIPTION OF THE PREFERRED EMBODIMENT

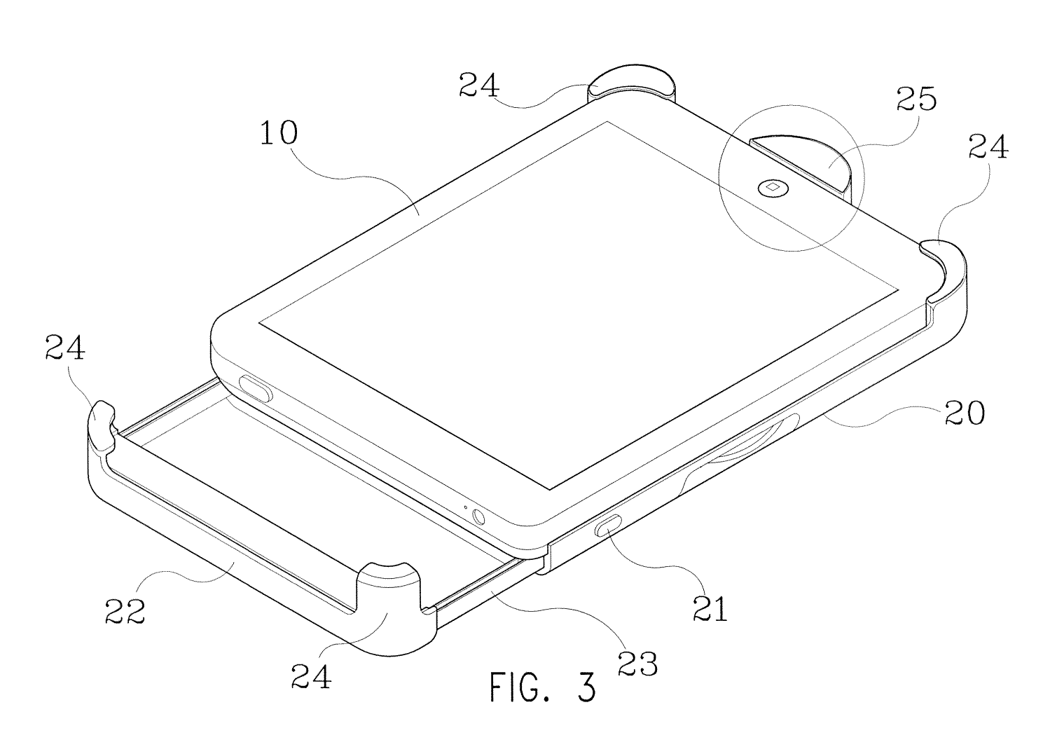

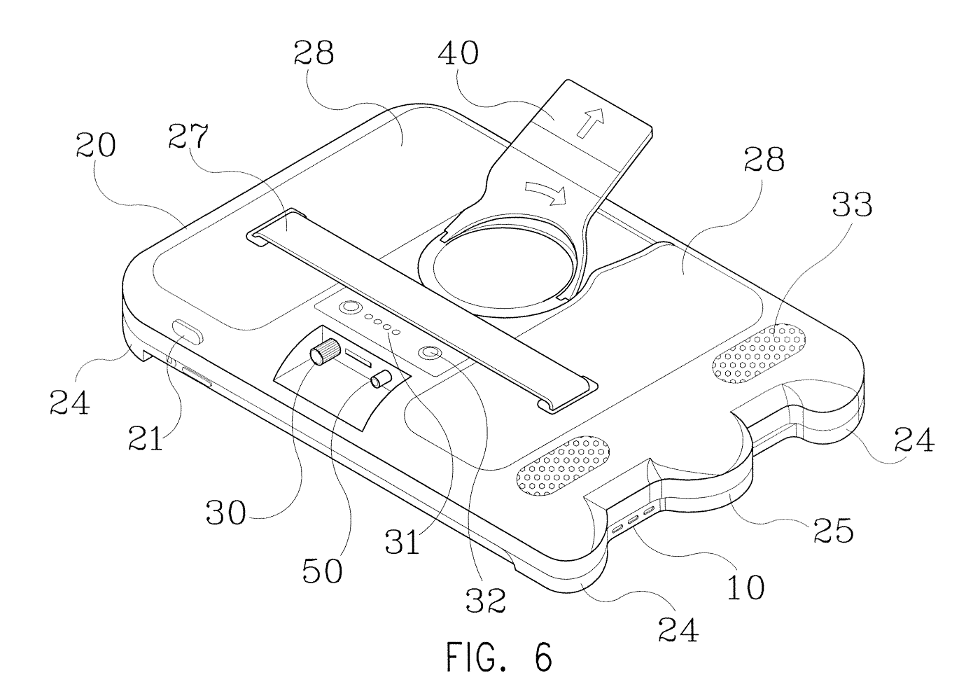

Referring to FIGS. 3 and 6, an APPLE-iPad holder type battery pack in accordance with the present invention is configured for holding an APPLE-iPad 10 and charging the built-in battery of the APPLE-iPad 10.

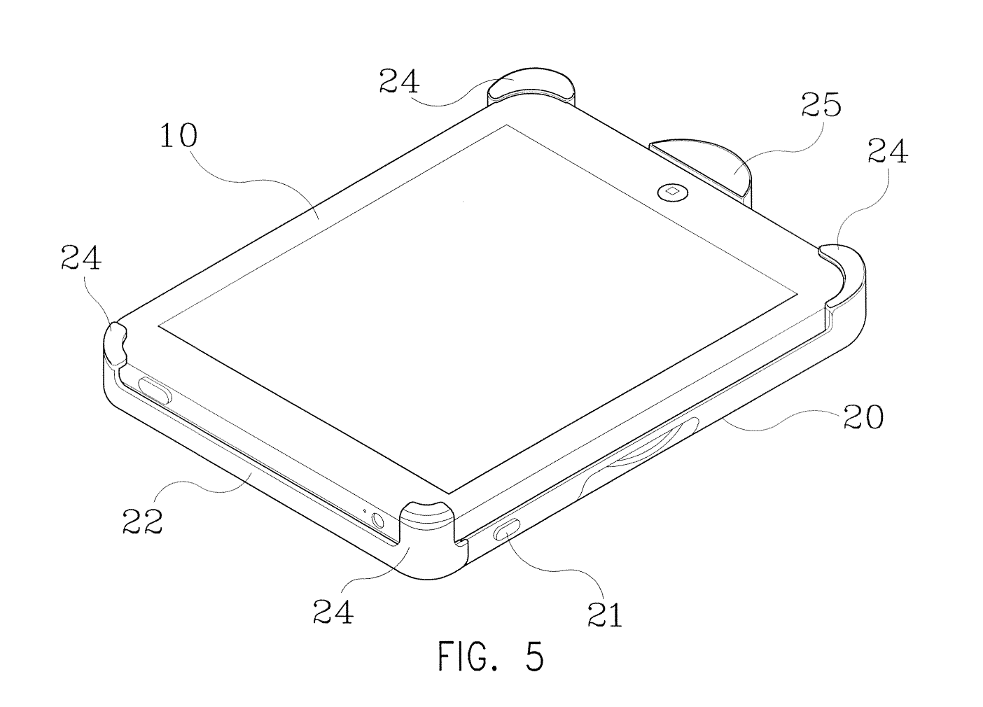

The APPLE-iPad holder type battery pack comprises a flat rectangular battery pack body 20 configured subject to the configuration of an APPLE-iPad 10, a flat rectangular spring-loaded sliding panel 22 having two opposing side rails 23 movable in and out of one short side of the battery pack body 20, a press button-controlled ratchet lock 21 installed in the battery pack body 20 for locking the spring-loaded sliding panel 22 and pressable to release the spring-loaded sliding panel 22, and a corner stop member 24 respectively fixedly located on each of two distal ends of one short side of the battery pack body 20 remove from the spring-loaded sliding panel 22 and each of two distal ends of one short side of the spring-loaded sliding panel 22 outside the battery pack body 20. When the user presses the button-controlled ratchet lock 21 to release the spring-loaded sliding panel 22, the spring-loaded sliding panel 22 can be moved relative to the battery pack body 20 between an extended position (see FIG. 3) for allowing insertion of an APPLE-iPad 10 into the battery pack body 20 and a received position where the inserted APPLE-iPad 10 is held firmly in the battery pack body 20 by the four corner stop member 24 (see FIG. 5). The battery pack body 20 has built therein a rechargeable battery and charging control circuit assembly (not shown). The rechargeable battery can be a Li-polymer battery cell. As the rechargeable battery and charging control circuit assembly of the battery pack body 20 is of the known art and not within the scope of the invention, no further detailed description in this regard is necessary.

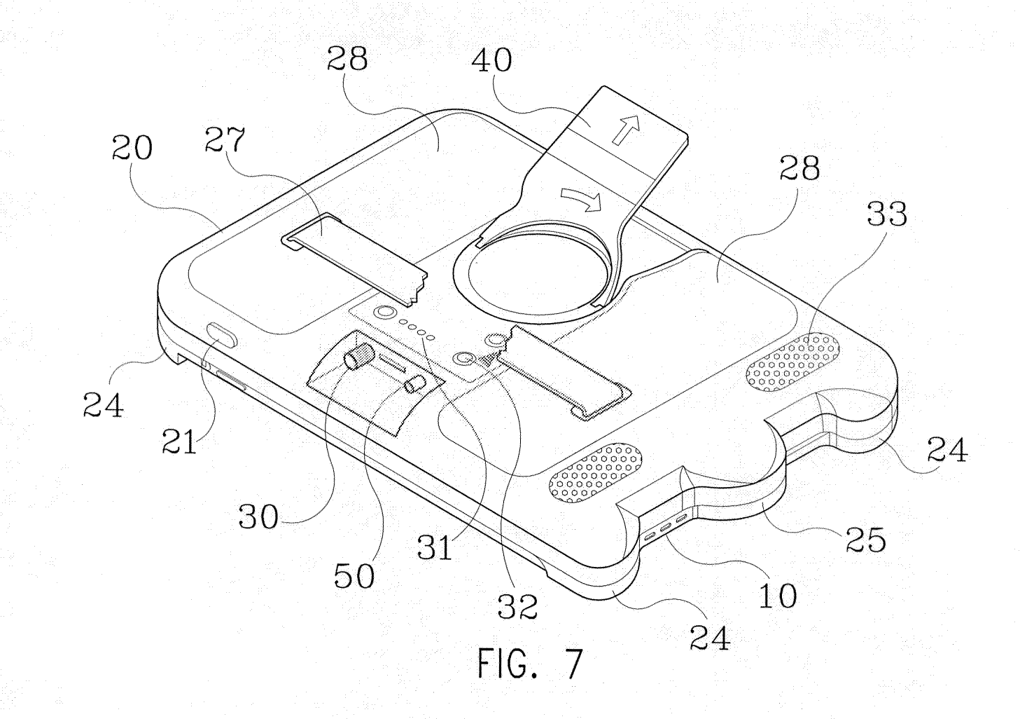

The APPLE-iPad holder type battery pack further comprises a locating block 25 located on one short side of the battery pack body 20 on the middle between the corresponding two corner stop members 24, an electrical connector 26 located on the locating block 25 (see FIG. 4) and electrically connected to the rechargeable battery and charging control circuit assembly for connection to the communication port 11 of the APPLE-iPad 10 held on the battery pack body 20 for power and signal transmission, a pair of high-definition speakers 33 located on the back side of the battery pack body 20 and electrically connected to the electrical connector 26 for output of audio signal from the APPLE-iPad 10 held on the battery pack body 20, a power jack 50 located on the battery pack body 20 at one lateral side for the connection of a APPLE-iPad charging cable to charge the rechargeable battery of the rechargeable battery and charging control circuit assembly in the battery pack body 20, a power switch 30 installed in the battery pack body 20 and operable to switch on/off electric connection between the rechargeable battery and charging control circuit assembly and the electrical connector 26, a power level indicator light set 31 installed in the battery pack body 20 and adapted for indicating the power level of the rechargeable battery of the rechargeable battery and charging control circuit assembly in the battery pack body 20, a volume control 32 installed in the battery pack body 20 and adapted for regulating the output volume of the speakers 33 (see FIG. 7), a hand belt 27 mounted on the back side of the battery pack body 20 to facilitate holding of the APPLE-iPad holder by hand. Further, leather pads 28 are bonded to the back side of the battery pack body 20, enhancing the image of noble and high quality.

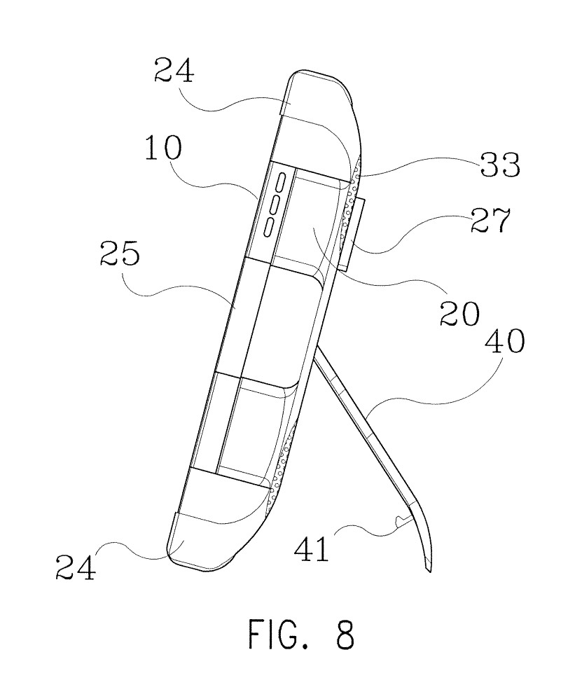

Further, a support 40 is pivotally hinged to the back side of the battery pack body 20 and biasable relative to the battery pack body 20 for supporting the battery pack body 20 on a flat surface in one of a series of tilting positions to facilitate the use of the supported APPLE-iPad 10 (see FIG. 8). The support 40 has a hook 41 for engaging a part of the battery pack body 20 to secure the support 40 in the non-operative position after the support 40 having been collapsed and closely attached to the back side of the battery pack body 20.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An APPLE-iPad holder type battery pack, comprising
a battery pack body configured subject to the configuration of an APPLE-iPad, said battery pack body having two opposing peripheral short sides, two opposing peripheral long sides, opposing front and back sides, a rechargeable battery and charging control circuit assembly built therein, at least one leather pad bonded to the back side thereof and two corner stop members respectively located on two distal ends of one peripheral short side thereof for supporting an APPLE-iPad on the front side of said battery pack body, a locating block located on one peripheral short side between the two corner stop members thereof;
two high-definition speakers installed in the back side of said battery pack body;
an electrical connector installed in said locating block and electrically connected with the built-in rechargeable battery and charging control circuit assembly of said battery pack body and said high-definition speakers for connection to one communication port of an APPLE-iPad held on said battery pack body for charging the built-in battery of the APPLE-Wad with the rechargeable battery and charging control circuit assembly of said battery pack body and transmitting an audio output signal from the APPLE-iPad to said high-definition speakers for output;
a hand belt mounted on the back side of said battery pack body;
a spring-loaded sliding panel having two opposing side rails coupled to and movable in and out of one peripheral short side of said battery pack body, said spring-loaded sliding panel comprising two stop members respectively fixedly located on two distal ends of one short side thereof outside said battery pack body and adapted for holding down an APPLE-iPad on the front side of said battery pack body;
a press button-controlled ratchet lock installed in one peripheral long side of said battery pack body and adapted to lock said spring-loaded sliding panel and pressable to release said spring-loaded sliding panel for allowing movement of said spring-loaded sliding panel relative to said battery pack body;
a power jack installed in one peripheral long side of said battery pack body for the connection of an APPLE-iPad charging cable to charge the built-in rechargeable battery of the rechargeable battery and charging control circuit assembly of said battery pack body with an external power source;
a power switch installed in the back side of said battery pack body and operable to switch on/off electric connection between the built-in rechargeable battery and charging control circuit assembly of said battery pack body and said electrical connector;
a power level indicator light set installed in the back side of said battery pack body and adapted for indicating the power level of the built-in rechargeable battery and charging control circuit assembly of said battery pack body;
a volume control installed in the back side of said battery pack body and adapted for regulating the output volume of said high-definition speakers; and
a support pivotally hinged to the back side of said battery pack body and biasable relative to said battery pack body for supporting said battery pack body on a flat surface in one of a series of tilting positions, said support having a hook for hooking on a part of said battery pack body to secure said support in a non-operative position.
